(19) United States
(12) Patent Application Publication
(10) Pub. No.: US 2010/0064149 A1
(43) Pub. Date: Mar. 11, 2010

(54) VOLTAGE ADJUSTING SYSTEM AND METHOD FOR MOTHERBOARD COMPONENTS OF A COMPUTER

(75) Inventors: DONG-HAI XUE, Shenzhen City (CN); DE-YUAN DONG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Taipei Hsien (TW)

(21) Appl. No.: 12/250,494

(22) Filed: Oct. 13, 2008

(30) Foreign Application Priority Data
Sep. 11, 2008 (CN) 200810304468.4

(51) Int. Cl. G06F 1/26

(52) U.S. Cl. 713/300

(57) ABSTRACT

A voltage adjusting system for motherboard components of a computer includes a basic input and output system (BIOS) and a voltage regulator. The BIOS includes an input module, a voltage detection module, and a voltage record module. The input module is for receiving an adjusted voltage of a motherboard component and providing the adjusted voltage to the voltage regulator to adjust a voltage of the motherboard component. The voltage detection module is for determining whether the motherboard component works normally under the adjusted voltage. The voltage record module is for receiving the adjusted voltage and storing the adjusted voltage in a memory system when the motherboard component works normally under the adjusted voltage.

### BACKGROUND

1. Field of the Invention

The present invention relates to voltage adjusting systems and methods, and particularly to a system and method for adjusting voltage values of motherboard components of a computer.

2. Description of Related Art

Each component of a motherboard of a computer is designed to operate in a certain voltage range, wherein damage to the component may be caused by voltage that exceeds a maximum voltage of the component. Thus, the voltage of the component needs to be adjusted.

One such method of adjusting the voltage is as follows. Firstly, a new voltage of the component is set in a basic input and output system (BIOS) of a computer. Secondly, the computer is restarted and a user determines whether the component works normally under the new voltage. If the component works abnormally at this time, damages can be caused by the new voltage and it becomes difficult for the user to deal with in time.

Therefore, it is desired to provide a voltage adjusting system and method to overcome the above described shortcomings.

### BRIEF DESCRIPTION OF THE DRAWINGS

FIG. 1 is a block diagram of an exemplary embodiment of a voltage adjusting system.

FIG. 2 is a flowchart of an exemplary embodiment of a voltage adjusting method for implementing the voltage adjusting system of FIG. 1.

### DETAILED DESCRIPTION

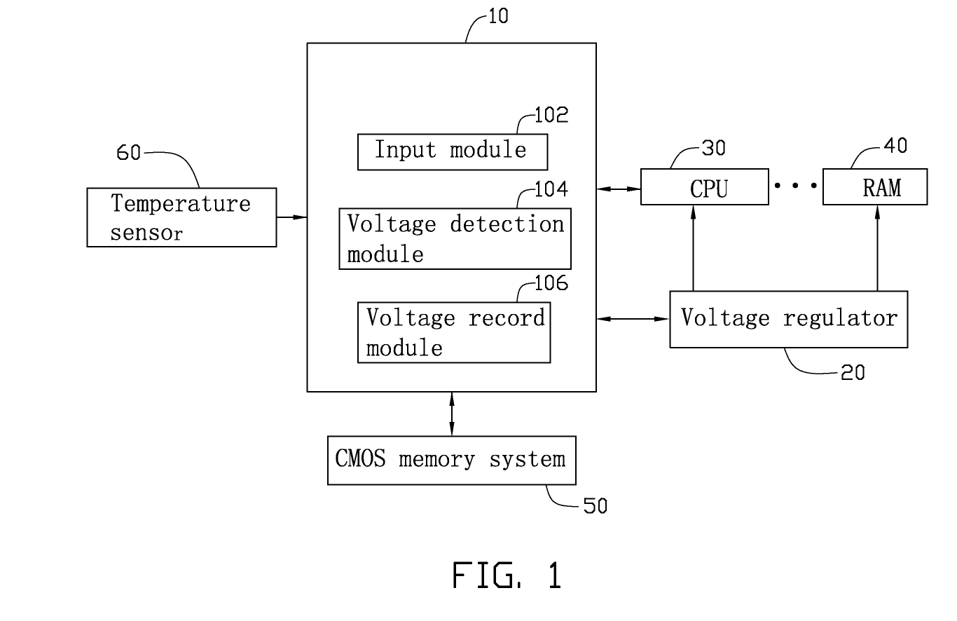

Referring to FIG. 1, an exemplary embodiment of a voltage adjusting system includes a basic input and output system (BIOS) 10, a voltage regulator 20, a complementary metal oxide semiconductor (CMOS) memory system 50, a temperature sensor 60, and a number of motherboard components, such as a central processing unit (CPU) 30, and a random access memory (RAM) 40, etc. The BIOS 10 includes an input module 102, a voltage detection module 104, and a voltage record module 106.

The input module 102 is configured for receiving an adjusted voltage of each motherboard component, and for providing the adjusted voltage to the voltage regulator 20.

The voltage regulator 20 adjusts the voltage of each motherboard component based on the adjusted voltage.

The voltage detection module 104 is configured for determining whether each motherboard component works abnormally under the adjusted voltage. If the motherboard component works abnormally, the voltage detection module 104 displays the abnormal information on a setting interface of the BIOS 10. If the motherboard component works normally, the voltage detection module 104 provides the adjusted voltage to the voltage record module 106.

The voltage record module 106 is configured for receiving the adjusted voltage, and for storing the adjusted voltage in a memory system, such as the CMOS memory system 50.

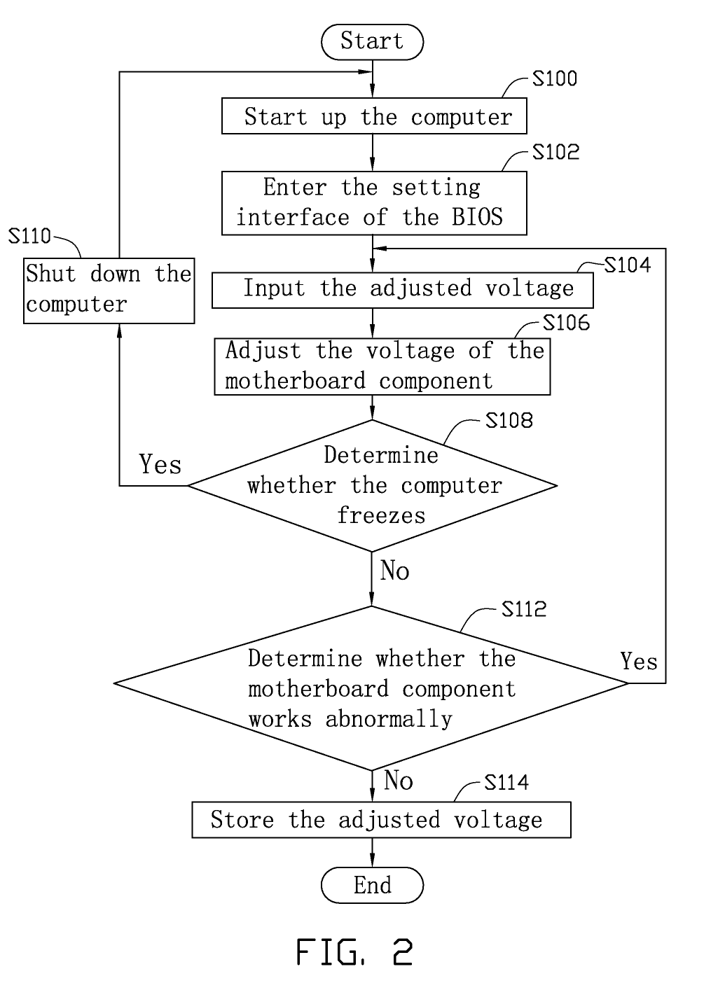

Referring to FIG. 2, an exemplary embodiment of a voltage adjusting method implementing the above mentioned voltage adjusting system includes the following blocks.

In block S100, the computer is started up.

In block S102, the BIOS 10 of the computer is invoked, and a setting interface of the BIOS 10 is displayed.

In block S104, an adjusted voltage corresponding to a motherboard component is input into the input module 102, and the input module 102 provides the adjusted voltage to the voltage regulator 20.

In block S106, the voltage regulator 20 adjusts the voltage of the motherboard component based on the adjusted voltage.

In block S108, does the computer freeze under the adjusted voltage? if the computer freezes, the procedure goes to the block S110, if the computer does not freeze, the procedure goes to the block S112.

In block S110, the computer is shut down and the procedure returns to the block S100 described above.

In block S112, the voltage detection module 104 determines whether the motherboard component works abnormally under the adjusted voltage. If the motherboard component works abnormally, the voltage detection module 104 displays the abnormal information on the setting interface of the BIOS 10, and the procedure returns to the block S104 described above. While the motherboard component works normally, the procedure goes to the block S114. For example, the voltage detection module 104 can obtain a temperature of the motherboard component via a temperature sensor 60 (shown in FIG. 1) to determine whether the motherboard component works abnormally under the adjusted voltage. The motherboard component works abnormally if the temperature of the motherboard component is higher than a predetermined temperature/value, and the motherboard component works normally if the temperature of the motherboard component is lower than the predetermined value. The temperature sensor 60 installed on the motherboard is configured for detecting the temperature of the motherboard component.

In block S114, the detection module 104 provides the adjusted voltage to the voltage record module 106, the voltage record module 106 receives the adjusted voltage and stores the adjusted voltage in the CMOS memory system 50.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A voltage adjusting system for adjusting voltage values for motherboard components of a computer, comprising:
a voltage regulator configured for adjusting a voltage of a motherboard component based on an adjusted voltage; and
a basic input and output system (BIOS) comprising:
an input module configured for receiving the adjusted voltage of the motherboard component, and providing the adjusted voltage to the voltage regulator;
a voltage detection module configured for determining whether the motherboard component works abnormally under the adjusted voltage; and
a voltage record module configured for receiving the adjusted voltage from the voltage detection module, and storing the adjusted voltage in a memory system upon a condition that the motherboard component works normally under the adjusted voltage;

2. The system of claim 1, wherein the memory system is a complementary metal oxide semiconductor (CMOS) memory system.

3. The system of claim 1, wherein the voltage detection module obtains a temperature of the motherboard component to determine whether the motherboard component works abnormally under the adjusted voltage; wherein the motherboard works abnormally upon a condition that the temperature of the motherboard component is higher than a predetermined value, and wherein the motherboard component works normally upon a condition that the temperature of the motherboard component is lower than the predetermined value.

4. The system of claim 1, wherein upon a condition that motherboard component works abnormally, the abnormal information of the motherboard component is displayed by the BIOS.

5. A voltage adjusting method for adjusting voltage values for motherboard components of a computer, comprising:
receiving an adjusted voltage of a motherboard component and providing the adjusted voltage to a voltage regulator, wherein the voltage regulator adjusts a voltage of the motherboard component based on the adjusted voltage;
determining whether the motherboard component works abnormally under the adjusted voltage; and
upon a condition that the motherboard component works normally, recording the adjusted voltage and storing the adjusted voltage in a memory system.

6. The method of claim 5, wherein upon a condition that the motherboard component works abnormally, returns to the block of receiving an adjusted voltage of a motherboard component and providing the adjusted voltage to the voltage regulator.

7. The method of claim 5, further comprising detecting a temperature of the motherboard component to determine whether the motherboard component works abnormally under the adjusted voltage, wherein the motherboard component works abnormally upon a condition that the temperature of the motherboard component is higher than a predetermined value, and wherein the motherboard component works normally upon a condition that the temperature of the motherboard component is lower than the predetermined value.

8. The method of claim 5, wherein the memory system is a complementary metal oxide semiconductor (CMOS) memory system.
